(19) United States
(12) Patent Application Publication
(10) Pub. No.: US 2025/0290589 A1
(43) Pub. Date: Sep. 18, 2025

(54) BLOWER PIPE

(71) Applicant: YAMABIKO CORPORATION, Tokyo (JP)

(72) Inventors: Hiroki MUTOU, Tokyo (JP); Tomonori KAWADA, Tokyo (JP)

(73) Assignee: YAMABIKO CORPORATION, Tokyo (JP)

(21) Appl. No.: 19/055,591

(22) Filed: Feb. 18, 2025

(30) Foreign Application Priority Data
Mar. 12, 2024 (JP) 2024-038266

(51) Int. Cl. F16L 37/50; A01G 20/47

(52) U.S. Cl. CPC F16L 37/505; A01G 20/47

(57) ABSTRACT

A blower pipe comprises an intermediate pipe (a second pipe) including a circumferential positioning groove and an axial positioning groove, and a proximal pipe (a first pipe) including a first projection and a second projection on an outer peripheral surface thereof. The proximal pipe is connected to the intermediate pipe with the distal end portion of the proximal pipe being inserted in a proximal end opening of the intermediate pipe, the first projection being engaged with the circumferential positioning groove in a circumferential direction of the intermediate pipe, and the second projection being engaged with the axial positioning groove in an axial direction of the intermediate pipe.

### CROSS-REFERENCE TO RELATED APPLICATIONS

The present application claims the priority under 35 U.S.C. § 119 of Japanese Patent Application No. 2024-038266, filed on Mar. 12, 2024, the contents of which are hereby incorporated by reference in its entirety.

### BACKGROUND OF THE DISCLOSURE

### Field of the Disclosure

The present disclosure relates to a blower pipe.

### Description of the Related Art

In a power blower (a blower) for carrying out operations such as cleanup work for fallen leaves and dust, a blower pipe is connected to a discharge port provided on a housing in order to discharge a high-speed airflow blasting out from the discharge port to a desired position. The blower pipe is formed to have a desired length by connecting two or more pipes.

An example of a connection structure for connecting a second pipe to a distal end portion of a first pipe of the blower pipe will be described. A groove portion that extends in a circumferential direction is formed on an inner peripheral surface of the second pipe, and a concave-convex surface is formed on an inner surface of the groove portion. Further, a projection is formed on an outer peripheral surface of the distal end portion of the first pipe.

When the first and second pipes are connected to each other, the distal end portion of the first pipe is inserted in a proximal end opening of the second pipe, while the second pipe is turned in a circumferential direction relative to the first pipe. In this way, the projection of the first pipe is put into the groove portion of the second pipe, and the distal end portion of the first pipe contacts a reduced diameter portion of the inner peripheral surface of the second pipe.

While the distal end portion of the first pipe contacts the reduced diameter portion of the second pipe, the projection of the first pipe is engaged with the groove portion of the second pipe, thereby restricting movements of the first and second pipes in an axial direction. Further, the projection of the first pipe is engaged with the concave-convex surface of the groove portion of the second pipe, thereby restricting movements of the first and second pipes in the circumferential direction. In this manner, the first and second pipes are connected to each other while preventing the first and second pipes from moving in the axial direction as well as the circumferential direction (see U.S. Pat. No. 8,210,577, for example).

In the above-described connection structure, many groove portions are formed in the axial direction of the second pipe. Specifically, the multiple groove portions are formed in the axial direction and many concavities and convexities are formed in the circumferential direction of the respective groove portions as well. Since the many groove portions as well as the concavities and the convexities are formed in the axial direction and the circumferential direction of the second pipe, the first and second pipes can be connected to each other by putting the projection of the first pipe into one of the groove portions of the second pipe even when a dimensional error in the pipes in the axial direction or the circumferential direction occurs. On the other hand, in the above-described connection structure, a connecting region of the second pipe has a complicated shape and also the connection structure is located away from end portions of both pipes. This makes an injection molding difficult to be selected, and a blow molding is selected as a pipe manufacturing method. As mentioned above, structural complexity of molds for manufacturing the pipes directly affects costs. In addition, since the options for the method of manufacturing the pipes are restricted, reducing the manufacturing costs may be limited.

The present disclosure aims to provide a blower pipe for solving the above-mentioned problem. The blower pipe is capable of reliably connecting two pipes to each other while simplifying a connection structure of the pipes, thereby reducing manufacturing costs.

### SUMMARY OF THE DISCLOSURE

To solve the problem, the present disclosure provides a blower pipe to be connected to an air discharge port provided on a power blower. The blower pipe includes a first pipe and a second pipe connected to a distal end portion of the first pipe. The second pipe includes a circumferential positioning groove and an axial positioning groove. The first pipe includes on an outer peripheral surface a first projection to be inserted in the circumferential positioning groove, and a second projection to be inserted in the axial positioning groove. The first pipe is connected to the second pipe with the distal end portion of the first pipe being inserted in a proximal end opening of the second pipe, the first projection being engaged with the circumferential positioning groove in a circumferential direction of the second pipe, and the second projection being engaged with the axial positioning groove in an axial direction of the second pipe.

The blower pipe of the present disclosure allows for downsizing and simplifying the connection structure of the first pipe and the second pipe by separately providing the circumferential positioning groove and the axial positioning groove on the connection structure. Movements of both pipes in an axial direction are restricted by engaging the second projection with the axial positioning groove with the first pipe being connected to the second pipe. Further, movements of both pipes in a circumferential direction are restricted by engaging the first projection with the circumferential positioning groove. As described above, in the blower pipe of the present disclosure, the axial positioning groove prevents the pipes from moving in the axial direction, allowing the structure of the circumferential positioning groove to be simplified. Further, extending the single circumferential positioning groove in the axial direction allows the pipes to tolerate dimensional errors in the axial direction without providing more than one circumferential positioning groove in the axial direction. This configuration allows for simplifying the connection structure of the pipes while ensuring easy manufacturing of the pipes. The blower pipe of the present disclosure simplifies the connection structure of the pipes while tolerating the dimensional errors, thereby to securely connect both pipes. This feature facilitates molding of the pipes and reduces manufacturing costs of the blower pipe. For example, the blower pipe of the present disclosure simplifies structures of molds for injection molding of the pipes, allowing for using an injection molding to manufacture the pipes. This results in expanding options for a method of molding the pipes, enabling a manufacturing method that involves lower costs to be selected.

### BRIEF DESCRIPTION OF THE DRAWINGS

FIG. 1 is a perspective view showing a power blower equipped with a blower pipe according to an embodiment of the present disclosure.

FIG. 2 is a view of a connection structure of the blower pipe according to the embodiment of the present disclosure, showing a perspective view of two pipes being connected to each other, viewed from a distal end side.

FIG. 3 is a view of the connection structure of the blower pipe according to the embodiment of the present disclosure, showing a perspective view of the two pipes before being connected to each other, viewed from the distal end side.

FIG. 4 is a view of the connection structure of the blower pipe according to the embodiment of the present disclosure, showing a perspective view of the two pipes before being connected to each other, viewed from a proximal end side.

FIG. 5 is a view of the connection structure of the blower pipe according to the embodiment of the present disclosure, showing a side view of the two pipes before being connected to each other.

FIG. 6 is a view of a connection structure of a blower pipe according to another embodiment of the present disclosure, showing a side view of two pipes before being connected to each other.

### DETAILED DESCRIPTION OF THE EMBODIMENTS

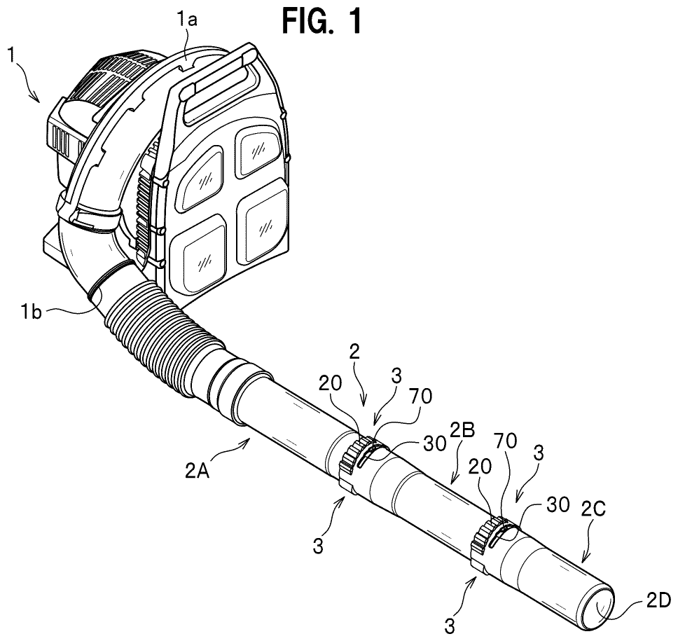

Embodiments of the present disclosure will be described in detail with reference to the drawings as appropriate. As shown in FIG. 1, a blower pipe 2 of the present embodiment is attached to a power blower 1 (a blower). The power blower 1 generates an airflow inside a housing 1a by rotating a fan (not shown) that is housed inside the housing 1a and powered by a power source (not shown) such as an engine and a motor. The housing 1a is provided with a discharge port 1b for discharging the airflow, and the discharge port 1b is connected to the blower pipe 2. The airflow is discharged from the distal end of the blower pipe 2 to the ground to blow fallen leaves and dust away.

The blower pipe 2 of the present embodiment is formed to have a desired length by connecting three pipes, namely, a proximal pipe 2A, an intermediate pipe 2B, and a distal pipe 2C. In general, the power blower 1 of a backpack type as shown in FIG. 1 is used with the connected three pipes because the housing 1a (the blower) is distant from the ground. In contrast, a power blower of a handheld type is used with two connected pipes because a housing (a blower) thereof is close to the ground. However, even in a case of the power blower 1 of the backpack type, such a power blower 1 can be used with the two connected pipes without the third pipe when an operator intends to use an air outlet 2D, which is provided at the distal end of the blower pipe 2, away from the ground. Hence, the operator can appropriately select the mode of connection depending on a work site.

The proximal pipe 2A is a cylindrical member made of resin, and has a proximal end detachably connected to the discharge port 1b of the housing 1a. The proximal pipe 2A has a base portion connected to a bellows portion bendable in a radial direction. For work, the operator takes advantage of flexibility of the bellows portion to swing the blower pipe 2 that is positioned close to the distal end far from the bellows portion, in a direction suitable to operation. A proximal end of the intermediate pipe 2B is connected to a distal end of the proximal pipe 2A. The intermediate pipe 2B is a cylindrical member made of resin. A proximal end of the distal pipe 2C is connected to a distal end of the intermediate pipe 2B. The distal pipe 2C is a cylindrical member made of resin. The air outlet 2D for the airflow is formed at a distal end of the distal pipe 2C.

The connection structure of the proximal pipe 2A and the intermediate pipe 2B is the same as the connection structure of the intermediate pipe 2B and the distal pipe 2C. In the connection structure of the proximal pipe 2A and the intermediate pipe 2B, the proximal pipe 2A corresponds to a “first pipe” in the scope of claims and the intermediate pipe 2B corresponds to a “second pipe” in the scope of claims. Further, in the connection structure of the intermediate pipe 2B and the distal pipe 2C, the intermediate pipe 2B corresponds to the “first pipe” in the scope of claims and the distal pipe 2C corresponds to the “second pipe” in the scope of claims.

In the following description, the connection structure of the proximal pipe 2A and the intermediate pipe 2B will be described while explanations of the connection structure of the intermediate pipe 2B and the distal pipe 2C will be omitted. An “axial direction” represents an extension direction of each pipe while a “circumferential direction” represents a circumferential direction of each pipe.

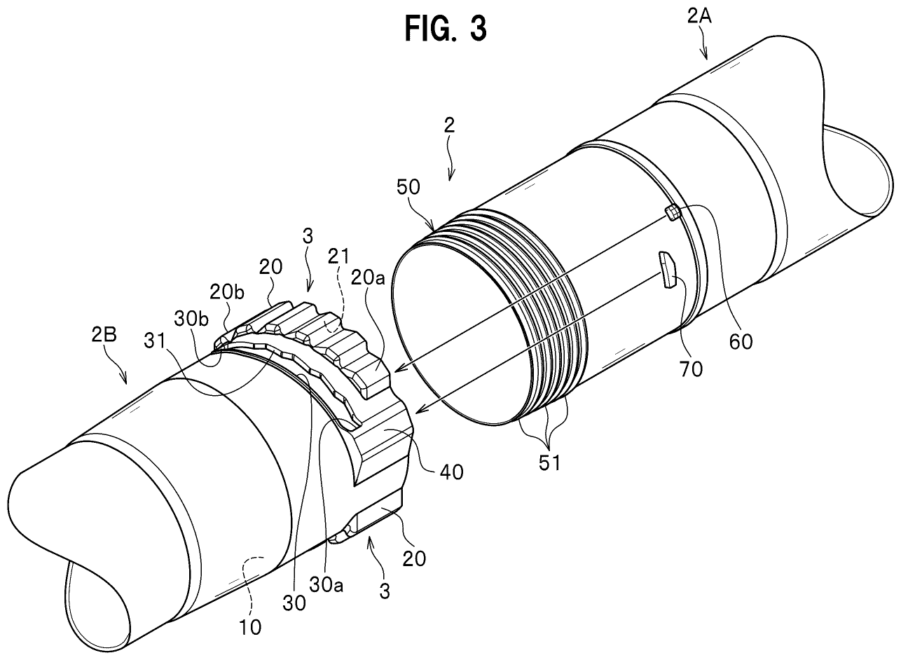

As shown in FIG. 3, the intermediate pipe 2B (a second pipe) includes a reduced diameter portion 10 formed on an inner peripheral surface of a base portion thereof. The reduced diameter portion 10 of the present embodiment has a tapered surface formed such that a part of the inner peripheral surface of the base portion of the intermediate pipe 2B gradually reduces in diameter as extending from the proximal end side toward the distal end side.

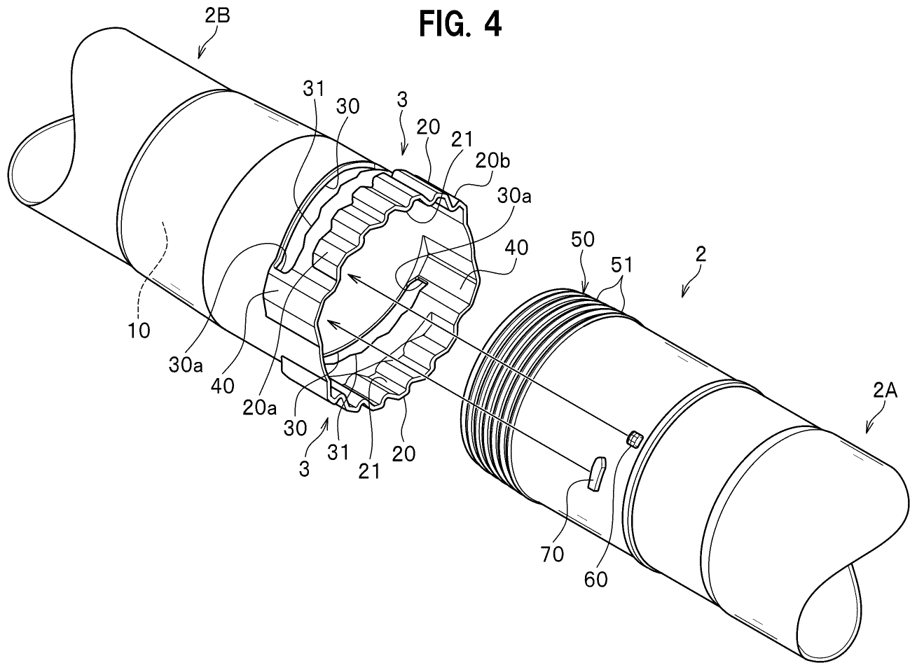

The intermediate pipe 2B includes two connectors 3, 3 on a region closer to the proximal end than the reduced diameter portion 10. The two connectors 3, 3 each include a circumferential positioning groove 20, an axial positioning groove 30, and an insertion groove portion 40 as shown in FIG. 4. The two connectors 3, 3 are formed and positioned such that a center point of a proximal end opening of the intermediate pipe 2B serves as a symmetric point for the connectors 3, 3.

The circumferential positioning groove 20 is positioned at the proximal end portion of the intermediate pipe 2B. The circumferential positioning groove 20 extends with a predetermined length in the circumferential direction of the intermediate pipe 2B, and extends with a predetermined length in the axial direction from a proximal end rim portion of the intermediate pipe 2B toward the distal end side thereof. The circumferential positioning groove 20 is a groove that is recessed outward in a radial direction of the intermediate pipe 2B from the inner peripheral surface of the intermediate pipe 2B. In the circumferential positioning groove 20, a side portion on the proximal end side of the intermediate pipe 2B is open. In other words, the proximal end portion of the circumferential positioning groove 20 is open in the axial direction.

In the present embodiment, two circumferential positioning grooves 20, 20 are arranged respectively on semiperimeters in the circumferential direction of the intermediate pipe 2B. Here, a length in the axial direction of the connection structure only needs to have a length in a range from about 29 to 71.5 mm, and this length is set to 42.5 mm in the present embodiment. A length in the axial direction is set to 105.5 mm in existing connection structures of the related art. Accordingly, the length of the connection structure of the present embodiment is significantly shorter than those of the related art.

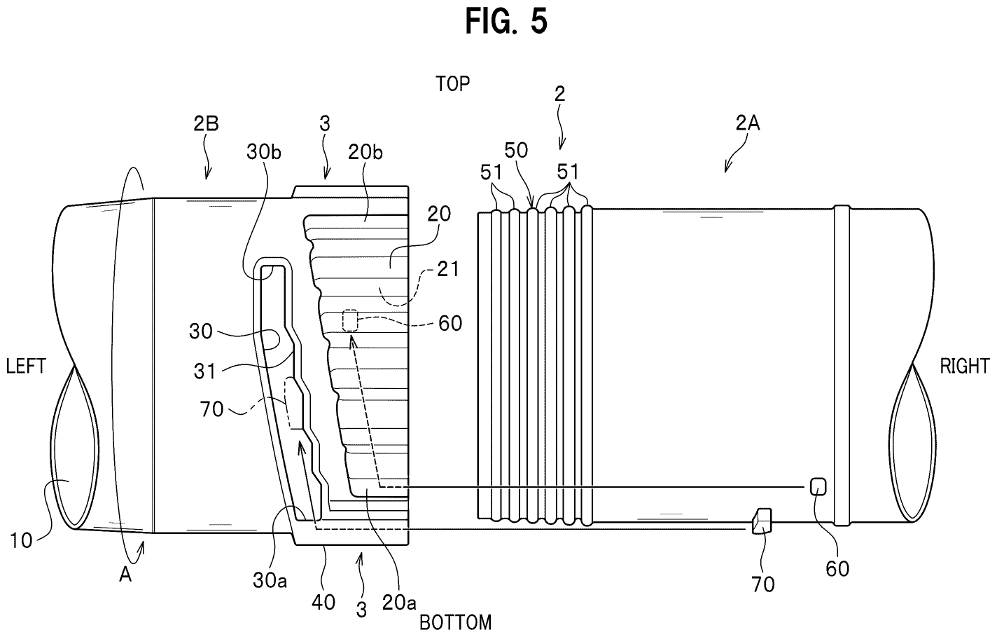

As shown in FIG. 5, a width in the axial direction of the circumferential positioning groove 20 gradually increases as extending from a first end portion 20a toward a second end portion 20b in the circumferential direction. In the present embodiment, the width of the circumferential positioning groove 20 in the axial direction gradually increases as extending toward an opposite direction to a rotational direction A shown in FIG. 5 (from the bottom to the top of FIG. 5). In the circumferential positioning groove 20, a rim portion on the distal end side in the axial direction is oblique relative to the circumferential direction of the intermediate pipe 2B (a vertical direction in FIG. 5) such that the rim portion is displaced from the proximal end side to the distal end side (from the right side to the left side in FIG. 5) of the intermediate pipe 2B as extending from the first end portion 20a to the second end portion 20b. When the intermediate pipe 2B is connected to the proximal pipe 2A, a slope at the rim portion on the tip end side of the circumferential positioning groove 20 can be used to turn the intermediate pipe 2B in the circumferential direction relative to the proximal pipe 2A, thereby to thrust the intermediate pipe 2B in the axial direction.

As shown in FIG. 4, the circumferential positioning groove 20 has a bottom surface (an inner surface of the intermediate pipe 2B outward in the radial direction) provided with a concave-convex surface 21 on which concavities and convexities are continuously formed in the circumferential direction. The inner peripheral surface of the intermediate pipe 2B is recessed to form a plurality of concavities that are arranged in the circumferential direction, which results in forming the convexities between the adjacent concavities, thereby continuously forming the concavities and convexities. Here, a thickness of a bottom portion of the circumferential positioning groove 20 may be changed to form the concave-convex surface 21 on only the inner surface. Alternatively, the concave-convex surface can be provided on also the outer surface corresponding to the concave-convex surface 21 on the inner surface of the intermediate pipe 2B, thereby to form the bottom portion of the circumferential positioning groove 20 with a constant thickness. In case of the concave-convex surface provided on the outer surface of the intermediate pipe 2B, the outer concave-convex surface can be gripped to turn the intermediate pipe 2B, which improves workability when connecting the proximal pipe 2A to the intermediate pipe 2B.

The insertion groove portion 40 extends in the axial direction from the proximal end rim portion of the intermediate pipe 2B toward the distal end side thereof. The insertion groove portion 40 is a groove portion that is recessed outward in the radial direction of the intermediate pipe 2B from the inner peripheral surface of the intermediate pipe 2B. In the insertion groove portion 40, a side portion on a proximal end side in the axial direction is open. In other words, a proximal end portion of the insertion groove portion 40 is open in the axial direction to receive a second projection 70, to be described below, of the proximal pipe 2A from the proximal end side of the insertion groove portion 40.

As shown in FIG. 3, the insertion groove portion 40 is positioned spaced from the first end portion 20a of the circumferential positioning groove 20 in the circumferential direction. The insertion groove portion 40 is larger in length than the circumferential positioning groove 20 in the axial direction, and is connected to the axial positioning groove 30, to be described below, at a distal end portion opposite to the proximal end in the axial direction. That is to say, the insertion groove portion 40 is a region to connect the opening at the proximal end portion of the intermediate pipe 2B to an end portion in the circumferential direction of the axial positioning groove 30.

As shown in FIG. 5, the axial positioning groove 30 extends in the circumferential direction of the intermediate pipe 2B. The axial positioning groove 30 is positioned on a distal end side in the axial direction relative to the circumferential positioning groove 20. The axial positioning groove 30 is an opening that penetrates the intermediate pipe 2B from an outer peripheral surface to the inner peripheral surface thereof. The axial positioning groove 30 has a first end portion 30a connected to a distal end portion of the insertion groove portion 40, and an inside of the axial positioning groove 30 communicates with an inside of the insertion groove portion 40. The axial positioning groove 30 is oblique relative to the circumferential direction of the intermediate pipe 2B (the vertical direction in FIG. 5) such that the axial positioning groove 30 is displaced from the proximal end side to the distal end side of the intermediate pipe 2B (from the right side to the left side in FIG. 5) as extending from the first end portion 30a toward the second end portion 30b on the insertion groove portion 40.

The axial positioning groove 30 has a proximal end rim portion (a rim portion on the right side in FIG. 5) in the axial direction formed with an oblique rim portion 31. The oblique rim portion 31 has a stepwise shape formed toward the distal end side of the intermediate pipe 2B (the left side in FIG. 5) as extending from one end (the first end portion 30a) to another end (the second end portion 30b) in the circumferential direction of the intermediate pipe 2B. That is to say, the oblique rim portion 31 is provided with multiple stepped portions. The oblique rim portion 31 is provided with multiple straight portions extending in the radial direction (the vertical direction in FIG. 5) of the intermediate pipe 2B and multiple oblique portions each formed between the adjacent straight portions and oblique to the straight portions.

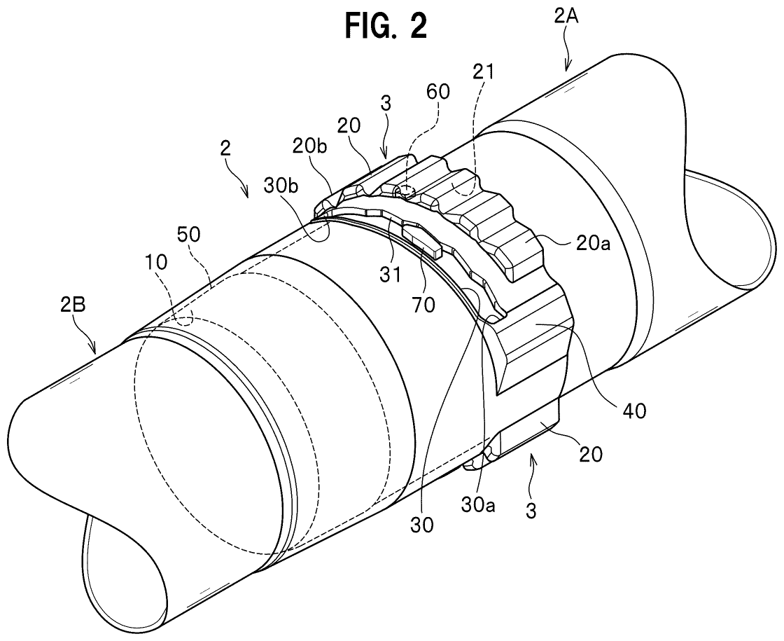

As shown in FIG. 3, the distal end portion of the proximal pipe 2A (the first pipe) has an outer peripheral surface provided with a contact portion 50, which is formed by arranging concave portions that are recessed over the entire circumference and convex portions 51 that project over the entire circumference alternately in the axial direction. As shown in FIG. 2, when the distal end portion of the proximal pipe 2A is inserted into a proximal end opening of the intermediate pipe 2B, the respective convex portions 51 of the proximal pipe 2A contact a peripheral surface of the reduced diameter portion 10 of the intermediate pipe 2B. Concavities and convexities are formed on the outer peripheral surface of the contact portion 50, which reduces a contact area of the contact portion 50 with respect to the peripheral surface of the reduced diameter portion 10. Accordingly, the distal end portion of the proximal pipe 2A is smoothly inserted into the intermediate pipe 2B in the insertion process of the proximal pipe 2A into the intermediate pipe 2B. Further, when the proximal pipe 2A is finally fixed to the intermediate pipe 2B, the convex portions 51 are being thrust into the inner peripheral surface of the intermediate pipe 2B. Accordingly, the intermediate pipe 2B is stably connected to the proximal pipe 2A.

As shown in FIG. 3, the outer peripheral surface of the proximal pipe 2A has a region on which a first projection 60 and the second projection 70 are formed and located on the distal end side relative to the contact portion 50. An additional first projection 60 and an additional second projection 70 (not shown) are also formed at positions on the outer peripheral surface of the proximal pipe 2A, which are point-symmetric to the first projection 60 and the second projection 70, respectively about a center point of a distal end opening of the proximal pipe 2A, serving as a symmetric point. That is to say, the set of the first projection 60 and the second projection 70 is provided on each semiperimeter of the blower pipe 2 corresponding to the positions of the circumferential positioning groove 20 and the axial positioning groove 30 provided on each semiperimeter of the blower pipe 2.

The first projection 60 is a region to be inserted in the first end portion 20a of the circumferential positioning groove 20 when the distal end portion of the proximal pipe 2A is inserted in the proximal end opening of the intermediate pipe 2B. The first projection 60 of the present embodiment is formed substantially into a cube. As shown in FIG. 5, a length in the axial direction of the first projection 60 is set significantly smaller than a length in the axial direction of the first end portion 20a of the circumferential positioning groove 20 so that the first projection 60 moves in the axial direction inside the circumferential positioning groove 20 when the first projection 60 is inserted in the circumferential positioning groove 20.

The first projection 60 has a vertex formed to be engaged in the circumferential direction with a concavity on the concave-convex surface 21 of the circumferential positioning groove 20. When the intermediate pipe 2B is turned in the circumferential direction relative to the proximal pipe 2A with the vertex of the first projection 60 being engaged with the concavity on the concave-convex surface 21, the first projection 60 goes over the convexity on the concave-convex surface 21 and moves to the adjacent concavity, and gets engaged therewith.

The first projection 60 is able to be engaged with any of the concavities provided on the concave-convex surface 21 of the circumferential positioning groove 20. The intermediate pipe 2B and the proximal pipe 2A are most stably connected to each other when the contact portion 50 provided at the distal end portion of the proximal pipe 2A closely contacts the inner peripheral surface of the intermediate pipe 2B and the first projection 60 is engaged with a prescribed concavity. As a result, the first projection 60 is engaged with any one of the concavities provided on the concave-convex surface 21 of the circumferential positioning groove 20 of the intermediate pipe 2B and the intermediate pipe 2B is stably connected to the proximal pipe 2A even when a dimensional error occurs while manufacturing between an outside diameter of the contact portion 50 of the proximal pipe 2A and an inside diameter of the intermediate pipe 2B.

The second projection 70 is positioned closer to the distal end (the left side in FIG. 5) of the proximal pipe 2A relative to the first projection 60. The second projection 70 is a region to be inserted in the insertion groove portion 40 when the distal end portion of the proximal pipe 2A is inserted in the proximal end opening of the intermediate pipe 2B. As shown in FIG. 3, the second projection 70 of the present embodiment is formed into a polygon having a large width in the circumferential direction.

When the intermediate pipe 2B is turned in the rotational direction A relative to the proximal pipe 2A with the second projection 70 being inserted in the distal end portion of the insertion groove portion 40 as shown in FIG. 5, the second projection 70 enters from the insertion groove portion 40 into the axial positioning groove 30. When the intermediate pipe 2B is further turned in the rotational direction A relative to the proximal pipe 2A while having the proximal pipe 2A enter into the distal end side of the intermediate pipe 2B, a side surface on a proximal end side of the second projection 70 contacts the oblique rim portion 31 of the axial positioning groove 30. Here, the side surface on the proximal end side of the second projection 70 is provided with a corner portion to be fitted into a bent portion formed from one of the straight portions and one of the oblique portions of the oblique rim portion 31.

Next, procedures for connecting the intermediate pipe 2B to the proximal pipe 2A will be described. As shown in FIG. 4, the proximal end portion of the intermediate pipe 2B is positioned closer to the distal end of the proximal pipe 2A, and the distal end side of the proximal pipe 2A is gradually inserted into the proximal end opening of the intermediate pipe 2B. In this instance, a position in the circumferential direction of the intermediate pipe 2B is aligned with the proximal pipe 2A such that the first projection 60 is inserted into the circumferential positioning groove 20 and the second projection 70 is inserted into the insertion groove portion 40.

The first projection 60 is inserted into the circumferential positioning groove 20 and the vertex of the first projection 60 is engaged with one of the concavities on the concave-convex surface 21. Further, the second projection 70 is inserted into the insertion groove portion 40. As shown in FIG. 5, after the intermediate pipe 2B is inserted into the proximal pipe 2A to such a position that the second projection 70 is inserted into the distal end portion of the insertion groove portion 40, the intermediate pipe 2B is turned in the rotational direction A relative to the proximal pipe 2A. Accordingly, the second projection 70 enters into the axial positioning groove 30.

When the intermediate pipe 2B is further turned in the rotational direction A relative to the proximal pipe 2A while having the proximal pipe 2A enter into the distal end side of the intermediate pipe 2B, the contact portion 50 of the proximal pipe 2A contacts the reduced diameter portion 10 of the intermediate pipe 2B as shown in FIG. 2. Further, the second projection 70 contacts the oblique rim portion 31 of the axial positioning groove 30. This restricts the movement in the axial direction of the intermediate pipe 2B relative to the proximal pipe 2A. Moreover, the first projection 60 is engaged with the concave-convex surface 21 on the circumferential positioning groove 20, and this restricts the movement in the circumferential direction of the intermediate pipe 2B relative to the proximal pipe 2A. As a result, the proximal pipe 2A is fixed to the intermediate pipe 2B in both the axial direction and the circumferential direction, and thereby, the proximal pipe 2A and the intermediate pipe 2B are connected to each other.

In the above-described blower pipe 2, the movements in the axial direction of the proximal pipe 2A and the intermediate pipe 2B are restricted by the axial positioning groove 30 of the intermediate pipe 2B as shown in FIG. 5. The circumferential positioning groove 20 needs to restrict the movements only in the circumferential direction of the proximal pipe 2A and the intermediate pipe 2B. This allows the circumferential positioning groove 20 to be formed as a single groove portion on the intermediate pipe 2B. As a consequence, the intermediate pipe 2B is provided with the concave-convex surface 21 that is long in the axial direction, allowing dimensional errors in the axial direction of the proximal pipe 2A and the intermediate pipe 2B to be tolerated.

The blower pipe 2 of the present embodiment therefore reliably connects the respective pipes 2A, 2B, and 2C shown in FIG. 1 while simplifying the connection structures of the respective pipes 2A, 2B, and 2C. Accordingly, the blower pipe 2 of the present embodiment allows for simplifying structures of molds used for injection molding of the respective pipes 2A, 2B, and 2C. This allows the blower pipe 2 to be produced with an injection molding to reduce manufacturing costs.

Further, the axial positioning groove 30 of the blower pipe 2 of the present embodiment is the opening that penetrates a cylindrical member as shown in FIG. 3. Accordingly, the mold is removed outward in the radial direction relative to an outer peripheral surface of the cylindrical member during the injection molding of the blower pipe 2. This facilitates the movement of the mold to reduce manufacturing costs.

In the blower pipe 2 of the present embodiment, the circumferential positioning groove 20 of the intermediate pipe 2B is arranged at the proximal end portion of the intermediate pipe 2B and the region located on the proximal end side of the circumferential positioning groove 20 is open as shown in FIG. 4. According to this configuration, the mold moves in the axial direction relative to the intermediate pipe 2B during the injection molding of the blower pipe 2 to form the circumferential positioning groove 20 with a simple mold structure. This facilitates the injection molding of the blower pipe 2.

In the blower pipe 2 of the present embodiment as shown in FIG. 3, the axial positioning groove 30 of the intermediate pipe 2B is arranged on the distal end side in the axial direction relative to the circumferential positioning groove 20. In this configuration, a space of the intermediate pipe 2B is effectively used to arrange the circumferential positioning groove 20 and the axial positioning groove 30. This allows multiple circumferential positioning grooves 20 and multiple axial positioning grooves 30 to be easily provided on the intermediate pipe 2B.

Here, the proximal pipe 2A may come off the intermediate pipe 2B when the axial positioning groove 30 is arranged at the proximal end portion of the intermediate pipe 2B with the axial positioning groove 30 being arranged on the proximal end side in the axial direction relative to the circumferential positioning groove 20. This requires the axial positioning groove 30 to be arranged with a predetermined distance away from the proximal end portion of the intermediate pipe 2B. Accordingly, the connection structure is increased in size in the axial direction because the cylindrical portion, the axial positioning groove 30, and the circumferential positioning groove 20 are arranged in this order from the proximal end side toward the distal end side of the intermediate pipe 2B. On the other hand, the connection structure can be formed in a compact size when the axial positioning groove 30 is arranged on the distal end side in the axial direction relative to the circumferential positioning groove 20 as in the present embodiment. Moreover, an overlapping length of the proximal pipe 2A and the intermediate pipe 2B in the axial direction can be shortened by bringing the connection structure closer to the proximal end of the intermediate pipe 2B. This reduces manufacturing costs and a weight of each of the proximal pipe 2A and the intermediate pipe 2B as a single member.

In the present embodiment, the oblique rim portion 31 of the axial positioning groove 30 of the intermediate pipe 2B has a stepwise shape as shown in FIG. 5. In this configuration, the second projection 70 is less likely to be misaligned in the circumferential direction relative to the oblique rim portion 31 since the second projection 70 is engaged with the stepped portion of the oblique rim portion 31. Thus, the intermediate pipe 2B is less likely to be turned in such a direction to come off the proximal pipe 2A (the opposite direction to the rotational direction A).

While the above-described embodiment discusses the connection structure of the proximal pipe 2A and the intermediate pipe 2B shown in FIG. 1, the connection structure of the intermediate pipe 2B and the distal pipe 2C adopts the same structure and has the same effects.

While a certain embodiment of the present disclosure has been described above, the present disclosure is not limited to the above-described embodiment and various modifications are possible as appropriate without departing from the scope of the disclosure. In the present embodiment, the circumferential positioning groove 20 and the axial positioning groove 30 of the intermediate pipe 2B are arranged in the axial direction as shown in FIG. 3. Instead, the circumferential positioning groove 20 and the axial positioning groove 30 may be arranged in the circumferential direction. In this case, the circumferential positioning groove 20 and the axial positioning groove 30 may be provided on each semiperimeter of the intermediate pipe 2B. Alternatively, a greater number of connecting portions may be provided in the circumferential direction of the intermediate pipe 2B by dividing the intermediate pipe 2B into one-third pieces or one-fourth pieces in the circumferential direction. While the axial positioning groove 30 is positioned on the distal end side of the intermediate pipe 2B relative to the circumferential positioning groove 20 in the present embodiment, the circumferential positioning groove 20 may be positioned on the distal end side of the intermediate pipe 2B relative to the axial positioning groove 30 instead.

The axial positioning groove 30 is the opening in the blower pipe 2 of the present embodiment. Instead, the axial positioning groove 30 may be formed by recessing the inner peripheral surface of the intermediate pipe 2B. Further, the oblique rim portion 31 of the axial positioning groove 30 is formed into the stepwise shape in the blower pipe 2 of the present embodiment. Instead, the oblique rim portion 31 may be formed into a straight shape or an arc shape. In the blower pipe 2 of the present embodiment, the contact portion 50 provided with the ring-shaped convex portions 51 is formed on the outer peripheral surface at the distal end portion of the proximal pipe 2A. However, the shape of the contact portion 50 is not limited. For example, at least one convex portion 51 may be formed. Further, the contact portion 50 may be designed to have convex portions in spiral shapes or in the form of projections, which are in close contact with the inner peripheral surface of the intermediate pipe 2B. Alternatively, the outer peripheral surface at the distal end portion of the proximal pipe 2A may be formed into a flat surface.

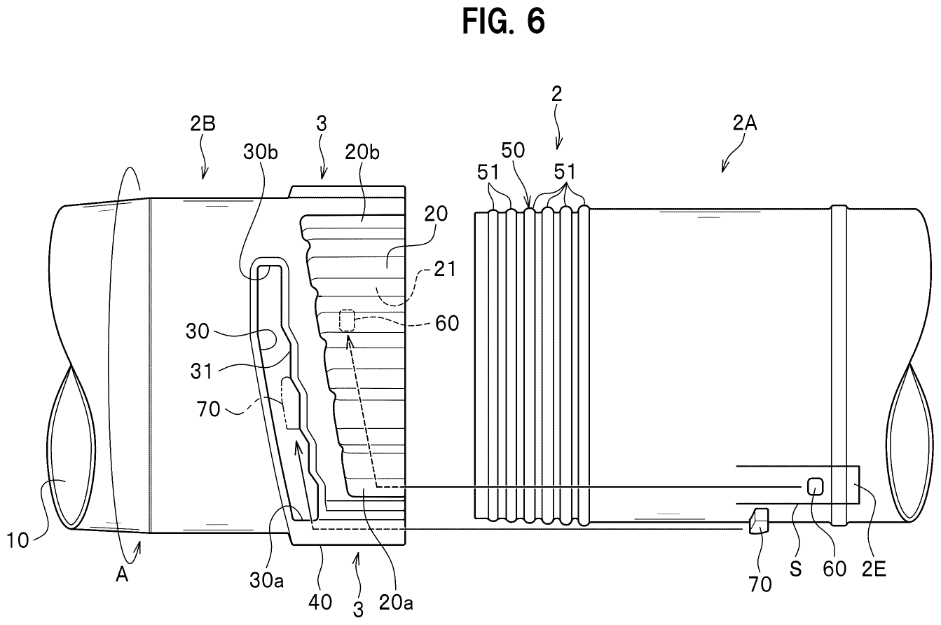

In a blower pipe 2 according to a different embodiment from the present embodiment, the outer peripheral surface of the proximal pipe 2A may be provided with a flexible portion 2E and the first projection 60 may be provided on an outer surface of the flexible portion 2E as shown in FIG. 6. The flexible portion 2E has slits S formed at both rim portions and a proximal end rim portion thereof. As the slits S partially separate the rim portions of the flexible portion 2E from the outer peripheral surface, the flexible portion 2E can be bent inward in the axial direction relative to the outer peripheral surface of the intermediate pipe 2B. In this configuration, when the intermediate pipe 2B is turned in the circumferential direction relative to the proximal pipe 2A and the first projection 60 goes over the convexity on the concave-convex surface 21 of the circumferential positioning groove 20, the first projection 60 is pushed to the inside in the radial direction of the intermediate pipe 2B together with the flexible portion 2E. This turns the intermediate pipe 2B smoothly in the circumferential direction relative to the proximal pipe 2A.

What is claimed is:

1. A blower pipe to be connected to an air discharge port provided on a power blower, the blower pipe comprising:
a first pipe; and
a second pipe connected to a distal end portion of the first pipe, wherein
the second pipe includes a circumferential positioning groove and an axial positioning groove,
the first pipe includes on an outer peripheral surface:
a first projection to be inserted in the circumferential positioning groove, and
a second projection to be inserted in the axial positioning groove, and
the first pipe is connected to the second pipe with
the distal end portion of the first pipe being inserted in a proximal end opening of the second pipe,
the first projection being engaged with the circumferential positioning groove in a circumferential direction of the second pipe, and
the second projection being engaged with the axial positioning groove in an axial direction of the second pipe.

2. The blower pipe according to claim 1, wherein
the circumferential positioning groove and the axial positioning groove extend in the circumferential direction of the second pipe,
the circumferential positioning groove is recessed outward in a radial direction of the second pipe from an inner peripheral surface of the second pipe,
the circumferential positioning groove has an inner concave-convex surface including continuous concavities and convexities in the circumferential direction of the second pipe,
the axial positioning groove includes an oblique rim portion that is located closer to the proximal end of the second pipe and is displaced toward a distal end of the second pipe as extending from a first end to a second end of the oblique rim portion in the circumferential direction of the second pipe, and
the first pipe is connected to the second pipe with
the distal end portion of the first pipe being inserted in the base end opening of the second pipe,
the second projection contacting the oblique rim portion of the axial positioning groove, and
the first projection being engaged with the concave-convex surface of the circumferential positioning groove.

3. The blower pipe according to claim 1, wherein the circumferential positioning groove and the axial positioning groove are arranged side by side in the axial direction of the second pipe.

4. The blower pipe according to claim 1, wherein
the circumferential positioning groove is disposed at a proximal end portion of the second pipe, and
the circumferential positioning groove includes an open region located closer to the proximal end of the second pipe.

5. The blower pipe according to claim 1, wherein the axial positioning groove is an opening through a cylindrical portion of the second pipe.

6. The blower pipe according to claim 2, wherein the oblique rim portion has a stepwise shape formed toward the distal end of the second pipe as extending from the first end to the second end in the circumferential direction of the second pipe.

7. The blower pipe according to claim 1, wherein
the first projection is positioned on an outer surface of a flexible portion provided on an outer peripheral surface of the second pipe, and
the flexible portion has flexibility in a radial direction of the second pipe.

8. The blower pipe according to claim 1, wherein
the second pipe includes a reduced diameter portion where a diameter of an inner peripheral surface of the second pipe is reduced, and
the first pipe is connected to the second pipe with the distal end portion of the first pipe being inserted in the proximal end opening of the second pipe and contacting the reduced diameter portion of the second pipe.

9. The blower pipe according to claim 8, wherein at least one convexity contacting a peripheral surface of the reduced diameter portion of the second pipe is projected from the outer peripheral surface at the distal end portion of the first pipe.
